(19) United States
(12) Patent Application Publication
(10) Pub. No.: US 2012/0104128 A1
(43) Pub. Date: May 3, 2012

(54) MIX BOXES FOR PREPARATION OF OIL SAND SLURRY

(75) Inventors: BARRY BARA, Edmonton (CA); ALAN FERRE, Fort McMurray (CA); CHRIS MOONEY, Fort McMurray (CA); JOHN DIEP, Burnaby (CA); DARWIN KIEL, New Westminster (CA); CHAD LARSON, Vancouver (CA); WALDEMAR MACIEJEWSKI, Edmonton (CA)

(73) Assignee: SYNCRUDE CANADA LTD. in trust for the owners of the Syncrude Project, Fort McMurray (CA)

(21) Appl. No.: 13/287,925

(22) Filed: Nov. 2, 2011

Related U.S. Application Data
(60) Provisional application No. 61/409,830, filed on Nov. 3, 2010.

(51) Int. Cl. B02C 19/00; B01F 5/00

(52) U.S. Cl. 241/30; 366/336; 366/338

(57) ABSTRACT

A method and a mix box for mixing oil sand and water to form a substantially uniformly mixed oil sand slurry is provided. The mix box has an open top end for receiving pre-crushed oil sand and water and a sloped bottom end having a discharge outlet and includes a plurality of profiled shelves positioned within the mix box. The substantially uniformly mixed oil sand has a substantially uniform flow distribution and therefore, when screened, reduces uneven wear on the screens.

This application claims priority to U.S. provisional patent application No. 61/409,830, filed Nov. 3, 2010.

### FIELD OF THE INVENTION

The present invention relates to mix boxes in general and more specifically to mix boxes useful in the preparation of uniformly mixed oil sand slurries.

### BACKGROUND OF THE INVENTION

The Athabasca Region of Alberta, Canada constitutes one of the largest deposits of oil sand in the world. The oil sand is first mined at a mine site and then transported to an extraction plant in order to extract the bitumen. In recent years the preferred mode of transport of mined oil sand has been by way of a slurry pipeline. The oil sand is mixed with water to form a slurry that is pumped down a pipeline to the extraction plant.

One needs to provide a suitable means for slurrying the oil sand with water and entraining air to produce a slurry that is suitable for pumping down the pipeline and subsequent bitumen recovery. The as-mined oil sand contains a variety of lumps including rocks, clay and oil sand lumps. Therefore a mixer means is required that not only slurries the oil sand but also ensures that oversize lumps that are unsuitable for pumping and feeding into the pipeline are rejected. A typical aqueous slurry comprises the following: bitumen froth, sand, smaller lumps of oil sand, clay and/or rocks (between 0 and 2 inches in diameter) and larger lumps of oil sand, clay and/or rock (between 2 and 4 inches in diameter).

In U.S. Pat. No. 5,039,227, one mixer circuit for slurrying oil sand with water has been disclosed. In this mixer circuit, an oil sand stream is dropped from the end of a conveyor into a mixer tank. The mixer tank is open-topped, has a cylindrical body and conical bottom and forms a central bottom outlet. A swirling vortex of slurry is maintained in the tank and the incoming oil sand and added water is fed into it. Slurry leaves the tank through the bottom outlet, is screened using vibrating screens to reject oversize, and is temporarily collected in an underlying pump box. Some of the slurry in the pump box is withdrawn and pumped back through a return line to be introduced tangentially into the mixer tank to form the swirling vortex. The balance of slurry in the pump box is withdrawn and pumped into the pipeline.

A second-generation mixer circuit in the form of a vertically oriented stack of components, which also functions to slurry the oil sand with water, is disclosed in U.S. Pat. No. 5,772,127. As-mined oil sand is initially crushed, for example, by passing it through a set of double rolls. The crushed oil sand is then initially dropped from the end of a conveyor and is contacted in mid-air with a stream of water. The mixture drops into a downwardly slanted trough and the water and oil sand mixes as they move turbulently through the open-ended trough. The slurry is deflected as it leaves the trough and is spread in the form of a thin sheet on an apron. It is then fed over a primary screen, e.g., a vibrating screen, to reject oversize lumps. The screened slurry drops into a pump box. The rejected lumps are comminuted in an impactor positioned at the end of the primary screen. The comminuted lumps are then screened through a secondary screen to remove remaining oversize lumps and the screened comminuted lumps are also delivered into the pump box. The slurry in the pump box is withdrawn and pumped into the pipeline.

Both of the prior art mixer circuits routinely produce a slurry that contains lumps ranging from 0 to 4 inches in diameter. The slurry must then travel down a hydrotransport pipeline, where slurry conditioning or digestion takes place. Adequate conditioning is critical for good bitumen recovery in a downstream separation vessel and is especially important when extracting bitumen from low grade oil sand. Basically what conditioning means is that the larger oil sand lumps are digested/ablated/dispersed into smaller lumps and bitumen flecks coalesce and coat or attach to air bubbles. The lumps need to be dispersed in water to promote the release of oil droplets and the attachment of air. Conditioning also benefits from turbulent pipeline flow and is dependent upon the length of the pipeline, hence, the length of time that the slurry resides in the pipeline before reaching the separation vessel. The larger the oil sand lumps, the more time required to digest or ablate these lumps to release the bitumen flecks. Therefore if a slurry is routinely produced that contains large lumps, there will be a need for longer pipelines with more residence time to ablate the lumps.

Further, in the second-generation mixer circuit, a problem was encountered with respect to blinding and uneven wear of the primary screens. The mixing of the crushed oil sand and water did not result in uniformly mixed oil sand slurry, in that portions of the oil sand slurry deposited on the screen would be too dry, causing blinding, and portions of the slurry would be wetter, causing more wear on the screens.

Thus, it is desirable to have a mixer circuit that produces more uniformly mixed oil sand slurries having smaller oil sand lump sizes, resulting in better oil sand slurry conditioning, more even wear on screens and ultimately improved bitumen recovery.

### SUMMARY OF THE INVENTION

The present invention relates to mix boxes in general and more specifically to mix boxes useful in the preparation of uniformly mixed oil sand slurries.

In one aspect of the present invention, a mix box for mixing oil sand and water to form a substantially uniformly mixed oil sand slurry is provided, comprising:
an open top end for receiving pre-crushed oil sand and water and a sloped bottom end having a discharge outlet; and
a plurality of profiled shelves positioned within the mix box.
   In one embodiment, the profiled shelves are convex and/or concave. In another embodiment, at least one of the profiled shelves has at least one flow diverter positioned at its trailing edge. In one embodiment, the flow diverters are trilateral pyramids in shape and can be staggered or aligned.

In another aspect, a mix box for mixing oil sand and water to form a uniform oil sand slurry is provided, comprising:
an open top end for receiving crushed oil sand and water and a bottom end having a discharge outlet for discharging the oil sand slurry; and
a plurality of shelves positioned within the mix box;
   wherein at least one shelf has at least one flow diverter positioned at its leading edge. In one embodiment, the flow diverters are trilateral pyramids in shape.

In another aspect, a method is provided for preparing an oil sand slurry, comprising:
crushing as-mined oil sand with at least one crusher or sizer to form pre-crushed oil sand; and
contacting the pre-crushed oil sand with water in a mix box comprising a plurality of shelves positioned within the mix box to form the oil sand slurry;
   whereby when the oil sand slurry exits the mix box it has a substantially uniform flow distribution.

In one embodiment, the mix box further comprises a sloped bottom end. In another embodiment, at least one shelf has at least one flow diverter positioned at its leading edge. In another embodiment, the shelves are profiled.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a schematic of an embodiment of the present invention showing a slurry preparation circuit comprising an embodiment of a mix box of the present invention.

FIG. 2 is a profile of the profiled shelves of the present invention.

FIG. 3 is a profile of shelves having flow diverters of the present invention.

FIG. 4 is a schematic of another embodiment of the present invention showing another slurry preparation circuit comprising another embodiment of a mix box of the present invention.

FIG. 5 is a side profile of shelves having flow obstructions of the present invention.

FIG. 6 shows a series of graphs showing the flow distribution and feed/water ratio of (1) unprofiled shelves (Original), (2) profiled shelves, and(3) shelves with tents

FIG. 7 is a bar graph showing the normalized standard deviation of spread of the Original Configuration, Aligned Tents and Staggered Tents.

### DETAILED DESCRIPTION OF THE PREFERRED EMBODIMENT

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

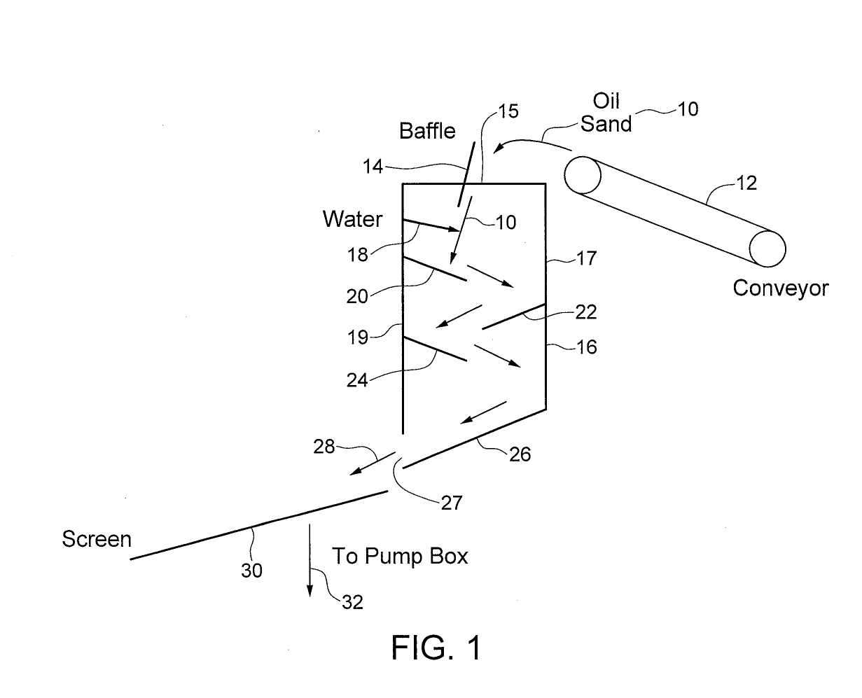

With reference now to FIG. 1, one embodiment of the present invention is illustrated herein comprising a mix box for the preparation of oil sand slurry from dry oil sand and water. Pre-crushed oil sand 10 is transported on conveyor 12 to the top of mix box 16. In one embodiment, mix box 16 comprises an open end 15 for receiving pre-crushed oil sand 10, two side walls 17, 19, a sloped bottom 26 having discharge outlet 27. Baffle 14 is provided at open end 15 to guide the pre-crushed oil sand 10 into mix box 16. Water 18 is contacted with the oil sand 10, for example, by spraying the water onto oil sand 10 when oil sand 10 drops from baffle 14, and then the mixture contacts shelf 20, which directs oil sand and water downwardly and outwardly towards side wall 17 and then drops on a second shelf, shelf 22. Shelf 22 then directs the oil sand and water to the opposite side wall 19 and the oil sand and water the drops on a third shelf, shelf 24. Shelf 24 again directs the oil sand and water against side wall 17 where by this point, the oil sand and water have been vigorously mixed to form oil sand slurry 28, which oil sand slurry 28 drops on sloped bottom 26 and is removed through discharge outlet 27 onto screen 30, which screen can be, for example, a vibrating screen. The screened oil sand 32 is then directed to a pump box (not shown), where it is pumped through a hydrotransport pipeline.

The more uniformly mixed the oil sand and water is will result in an oil sand slurry having a consistent texture, i.e., a more uniform water ratio across the mix box exit (discharge outlet 27). One advantage of having such a thoroughly and consistently mixed oil sand slurry is that it flows onto on screen 30 and uniformly spreads across the entire width of the screen, thereby preventing “hot spots” of wear on the screen due to large amounts of unmixed oil sand landing thereon.

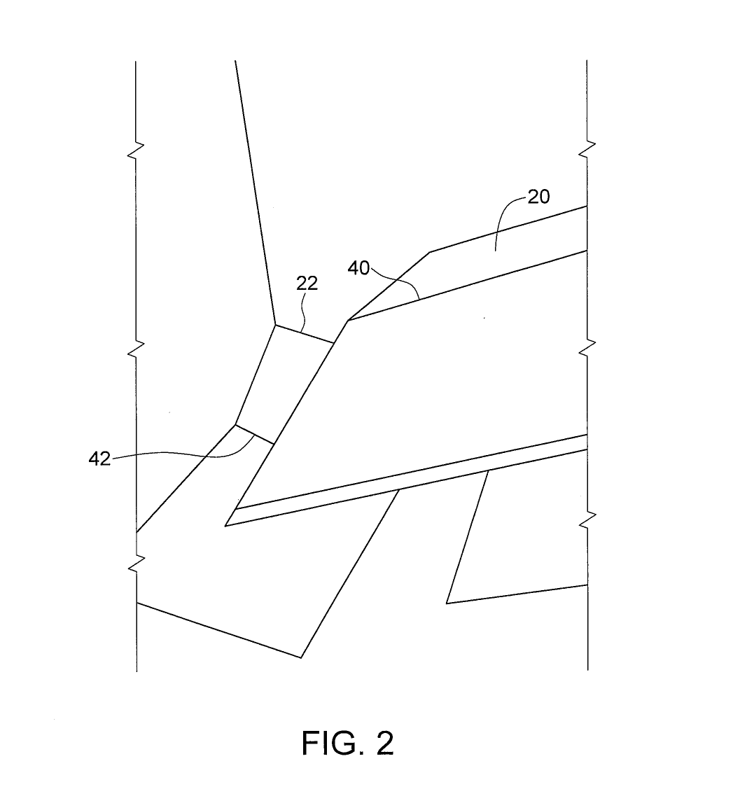

To promote as uniform mixing as possible, profiled shelves can be used. This can be seen in FIG. 2, where it is shown that shelves 20 and 22 are profiled. More particularly, the first shelf, shelf 20, is convex, having an apex or peak 40 and thus is generally roof-like in shape. Shelf 22, on the other hand, is concave, having an antapex 42 and thus is generally valley or gully-shaped. In one embodiment, shelf 24 is also convex much like shelf 20. By using shelves having alternating profiles as discussed above, this promotes more thorough mixing by aggressively throwing the oil sand and water contents of mix box 16 to the sides 17, 19 and center of the mix box.

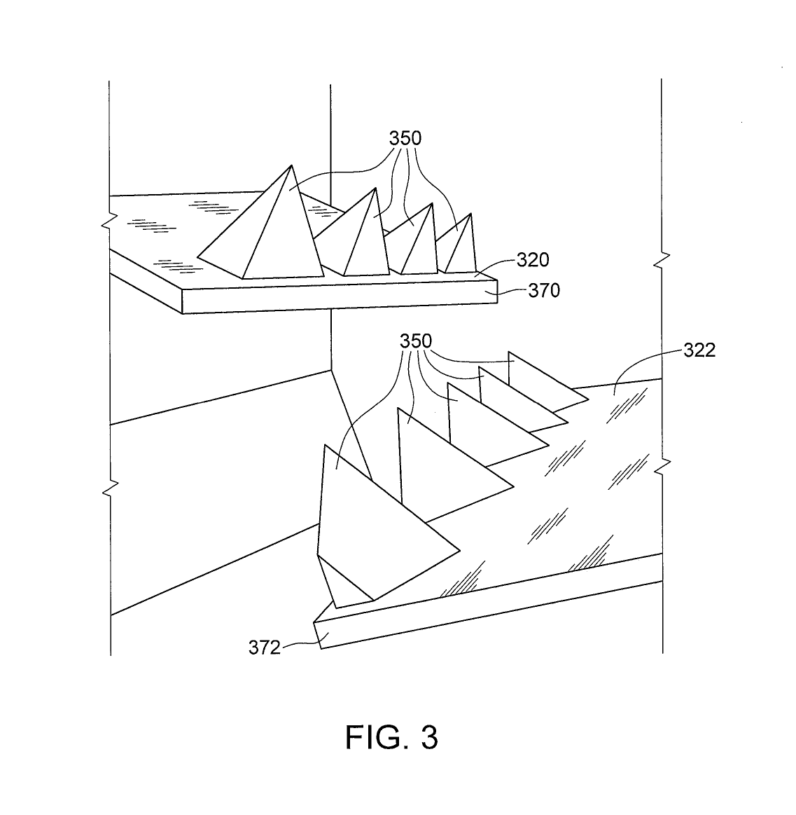

To further enhance a uniform flow distribution onto screen 30, FIG. 3 shows non-profiled shelves 320 and 322 having a plurality of trilateral pyramid-shaped flow diverters 350 at the leading edges, 370, 372, of shelves 320, 322, respectively, which flow diverters 350 create a uniform flow distribution onto the screen 30. It is understood that other shaped flow diverters can also be used. Thus, best performance of mix box 16 can be achieved by a combination of shelf profiles and flow diverters. The shelf profiles can be used to promote aggressive mixing of the oil sand and water within the mix box while the flow diverters can be installed, for example, on the discharge outlet 27 for enhanced flow distribution.

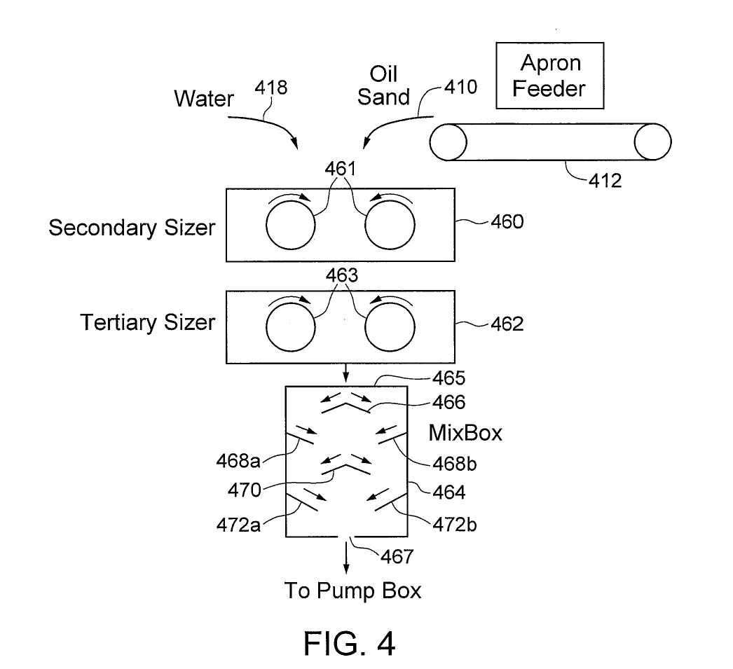

With reference now to FIG. 4, another embodiment of the present invention is illustrated herein whereby a mix box is used to more thoroughly mix an oil sand slurry that has initially been prepared in series of crushers. Pre-crushed (in a primary sizer) oil sand 410 is transported via conveyor or apron feeder 412 and fed, along with water 418, into a secondary sizer 460 comprising at least two crusher rollers 461 to crush the oil sand ore to a smaller, secondary size. The secondary sized oil sand ore and water is then fed into a tertiary sizer 462 comprising at least two crusher rollers 463 which crushes the oil sand ore to an even smaller, tertiary size. The tertiary sized oil sand and water mixture is then fed into mix box 464, where further mixing of the oil sand and water occurs. In one embodiment, additional water may be added to mix box 464.

Mix box 464 comprises two internal profiled, convex shelves, 466 and 470. In between the two profiled shelves 466 and 470 are downwardly slanting shelves 468a and 468b and below profiled shelf 470 are downwardly slanting shelves 472a and 472b. The orientation of the profiled shelves and the downwardly slanting shelves is such that the oil sand slurry is directed alternately outwardly towards the walls of the mix box 464 and then inwardly towards the center of the mix box 464. This lateral mixing results in a very uniformly mixed oil sand slurry. Oil sand slurry then exits the mix box 464 via discharge outlet 467 located at the bottom of mix box 464.

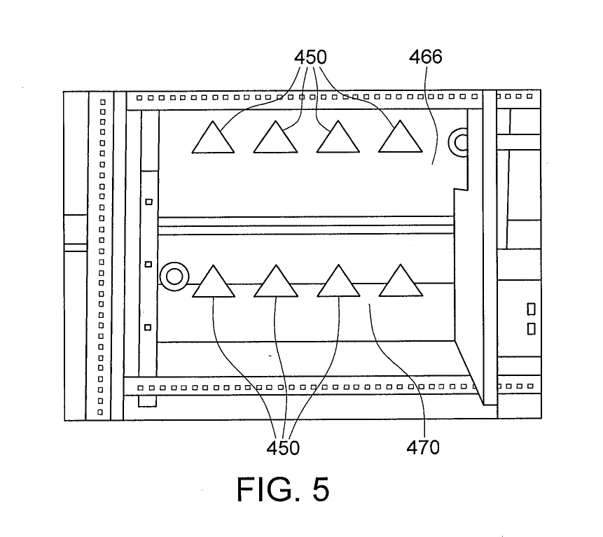

It was further discovered that the addition of trilateral pyramid-shaped flow diverters 450, as shown in FIG. 5, which were installed at the trailing edges of the profiled shelves 466 and 470, respectively, promoted enhanced lateral mixing. As shown in FIG. 5, flow diverters 450 on the upper profiled shelf 466 are in alignment with the flow diverters 450 on the bottom profiled shelf 470. It is understood that additional flow diverters can also be placed at the trailing edges of 468a, 468b, 472a or 472b or combinations thereof.

### EXAMPLE 1

Prototype mix boxes for preparing oil sand slurry from dry pre-crushed oil sand and water were constructed using three different shelves: (1) non-profiled shelves (“Original”); (2) profiled shelves (“Shelf Profiles”), as shown in FIG. 2, and (3) non-profiled shelves having flow diverters (“Tents”), as shown in FIG. 3. Each prototype mix box was tested for flow distribution and feed/water ratio at various locations from the center of the mix box (bin), where the center of the mix box (bin) is zero (0), the left hand side of the mix box is indicated by increasing negative numbers and the right hand side of the mix box is indicted by increasing positive numbers.

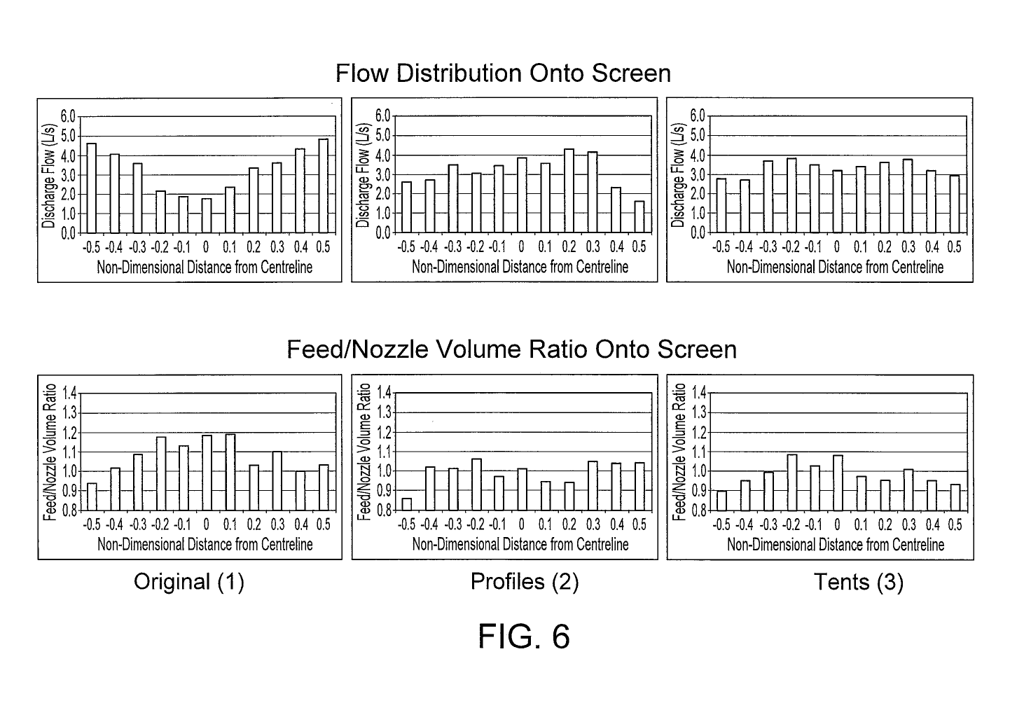

It can be seen from FIG. 6, that, with respect to Flow Distribution (measured as volumetric flow L/s), with (1), the Original design, the flow was considerably less in the center of the mix box as opposed to the walls of the mix box. This would result in an uneven distribution of slurry onto the screens and thus uneven wear, in particular, where the sides of the screens would wear quicker than the center. However, the use of (2) Shelf Profiles resulted in a more uniform flow distribution across most of the width of the mix box. The use of (3) Tents resulted in the most uniform flow distribution across the entire width of the mix box. Thus, the use of shelf profiles and/or tents would result in more even wear of the screens.

It can be further seen from FIG. 6, that, with respect to Feed/Water Ratio onto screens (measured as feed/nozzle volume ratio), with (1), the Original design, the feed/water ratio was higher in the center of the mix box as opposed to the walls of the mix box. This would result in drier, slower moving oil sand slurry exiting from the center of the mix box onto the screen, thus, potentially resulting in blinding of the screen in this region. Also, the wetter oil sand slurry moves more quickly on the sides, thereby causing more uneven screen wear on the sides of the screen. However, the use of either (2) Shelf Profiles or (3) Tents resulted in a more uniform flow distribution across the entire width of the mix box.

### EXAMPLE 2

Prototype mix box was designed as shown in FIG. 4 and FIG. 5 having (1) the original configuration (no flow diverters), (2) aligned flow diverters (“aligned tents”) and (3) staggered flow diverters (“staggered tents”). A tracer was added at the top of the mix box and the spread of the tracer at the bottom of the mix box was measured. The measured standard deviations of the spread are relative to the original configuration.

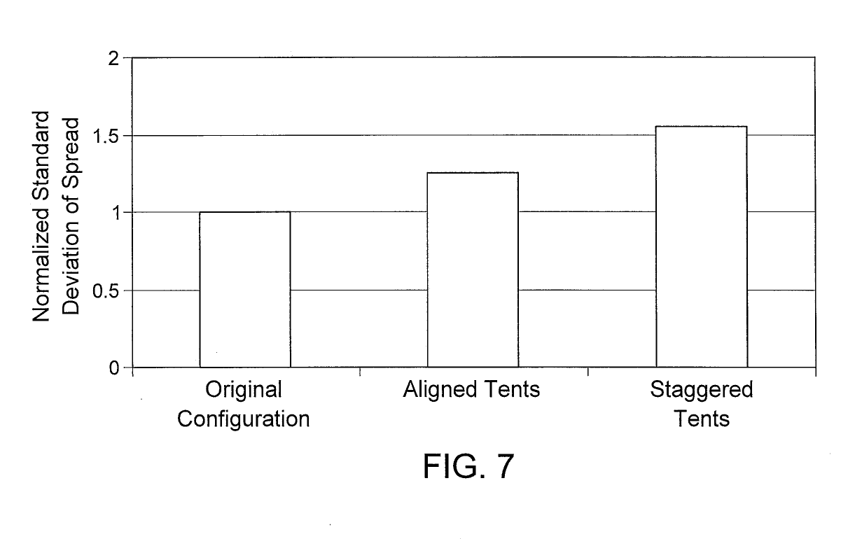

It can be seen in FIG. 7 that for the aligned tents, there was about a 25% increase in the spread of the tracer as compared to the original configuration. If the tents were staggered, there was an increase in spread of over 50% compared to the original configuration.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A mix box for mixing oil sand and water to form a substantially uniformly mixed oil sand slurry, comprising:
an open top end for receiving pre-crushed oil sand and water and a sloped bottom end having a discharge outlet; and
a plurality of profiled shelves positioned within the mix box.

2. The mix box as claimed in claim 1, wherein the profiled shelves are convex and/or concave.

3. The mix box as claimed in claim 1, wherein at least one of the profiled shelves has at least one flow diverter positioned at its trailing edge.

4. The mix box as claimed in claim 3, wherein the at least one flow diverter is trilateral pyramid in shape.

5. The mix box as claimed in claim 3, wherein the at least one of the profiled shelves has two or more flow diverters that are staggered.

6. The mix box as claimed in claim 3, wherein the flow diverters are aligned.

7. A mix box for mixing oil sand and water to form a uniform oil sand slurry, comprising:
an open top end for receiving pre-crushed oil sand and water and an open bottom end having a discharge outlet for discharging the oil sand slurry; and
a plurality of shelves positioned within the mix box;
wherein each shelf has at least one flow diverter positioned at its leading edge.

8. The mix box as claimed in claim 7, wherein the flow diverters are trilateral pyramids in shape.

9. A method for preparing an oil sand slurry, comprising:
crushing as-mined oil sand with at least one crusher or sizer to faun pre-crushed oil sand; and
contacting the pre-crushed oil sand with water in a mix box comprising a plurality of shelves positioned within the mix box to form the oil sand slurry;
whereby when the oil sand slurry exits the mix box it has a substantially uniform flow distribution.

10. The method as claimed in claim 9, wherein the mix box further comprises a sloped bottom end.

11. The method as claimed in claim 9, wherein at least one of the shelves has at least one flow diverter positioned at its leading edge.

12. The method as claimed in claim 9, wherein the shelves are profiled.
